(19) United States
(12) Patent Application Publication
(10) Pub. No.: US 2001/0013578 A1
(43) Pub. Date: Aug. 16, 2001

(54) Ion implantation equipment and implantation method thereof

(76) Inventors: Takayoshi Seki, Hitachi-shi (JP); Katsumi Tokiguchi, Mito-shi (JP)

Correspondence Address: MATTINGLY, STANGER & MALUR, P.C., 104 East Hume Avenue, Alexandria, VA, 22301, US

(21) Appl. No.: 09/756,922

(22) Filed: Jan. 10, 2001

(30) Foreign Application Priority Data
Feb. 15, 2000 (JP) 2000-36016

(51) Int. Cl. G21K 1/08

(52) U.S. Cl. 250/396 R

(57) ABSTRACT

In order to adjust an orbit of ion beam scanned by a magnetic field, the ion beam having a specified mass is extracted by deflecting the ion beam 100 from the ion sounce 100 along a XZ surface with the mass separator 12, this ion beam 100 is accelerated with the after-acceleration pipe 16, and this ion beam 100 is scanned along XZ surface by changing the magnetic field strength in time with the electromagnet 18. The scanned ion beam 100 is corrected its scan angle in a scan surface of the ion beam 100 by changing the magnetic field strength in time with the electromagnet 20 for the angle correction, and the corrected ion beam 100 is inplanted into the wafer 34.

### BACKGROUND OF THE INVENTION

The present invention relates to an ion implantation equipment and an implantation method thereof, and especially relates to the ion implantation equipment and the implantation method thereof which is suitable for implanting ions to an implantation target while scanning with an ion beam.

As an ion implantation equipment for implanting ions into a wafer (substrate), a magnetic field scan type ion implantation equipment is conventionally known in which plurality of the wafer are installed on a rotating disk, the ion beam from an ion sounce is transmitted to a wafer turning with the rotating disk, and the ions are implanted on an entire surface of the wafer while scanning an ion beam by using a magnetic field. In this magnetic field scan type ion implantation equipment, the ion beam which occurred from an ion sounce is deflected by a fixed magnetic field, an ion beam having a specified mass from the ion beam which occurred from the ion sounce, for example, an ion beam of O+, is separated so as to be extracted, the extracted ion beam is deflected in an vertical surface (YZ side) corresponding to a deflection surface of the mass separator (XZ side) by generating a fixed magnetic field with an electromagnet for scanning it, this deflected ion beam is given a fixed magnetic field with an electromagnet for correcting an angle thereof, and the ion beam is deflected in the YZ surface so as to be implanted with a same implantation angle in all surface of the wafers. In this case, as the electromagnet for scanning and the electromagnet for correcting the angle form the fixed magnetic field that the magnetic field strength does not change in time, in a case that it is scanned in a right angle direction for the deflection surface (XZ surface) of the mass separator in the electromagnet for scanning and the electromagnet for correcting the angle, an end of the magnetic pole forming a transmiss ion channel of the ion beam among magnetic poles of the electromagnet for scanning and the electromagnet for correcting the angle is processed so as to form a curvature face, and a shape of this curvature surface can corrects a change of a beam width of the scanned ion beam. Such a conventional ion implantation equipment is shown in U.S. Pat. No. 4,276,477, for example.

In the above conventional technology, as the electromagnet for scanning and the electromagnet for angle are provided to form a fixation magnetic field in which the magnetic field strength does not change in time, the ends of magnetic poles of the electromagnet for scanning and the electromagnet for correcting the angle are needed to be processed so as to form a curvature face in order to scan the ion beam, and the processing of the magnetic pole is difficult and a lot of time is needed for the processing working. In addition, a location of the electromagnet for the scan and the electromagnet for the angle correction is decided by a convergence point of the ion beam, and respective electromagnets are fixed on the determined location, therefore, a beam shape of the ion beam changes with an implanting condition of the ion sounce, and when an orbit of the ion beam is different from that in designing, it is difficult to correct the orbit of the ion beam and homogeneity of the ion implanted in the wafer becomes worsen. Furthermore, depending on the shape of the magnetic pole of the each magnet, a rate to change the shape of the ion beam becomes big with the scanning of the ion beam.

### SUMMARY OF THE INVENTION

The object of the present invention is in providing an ion implantation equipment and method which can adjust an orbit of the ion beam by the magnetic field.

In order to achieve the above object, the present invention provides an ion implantation equipment having an ion sounce, a mass isolation means in which the ion beams generated from the ion sounce are deflected by adding a magnetic field and an ion beam having a specified mass is separated to be extracted from these ion beams, a scan means for scanning the ion beam extracted by said mass isolation means by adding magnetic field changing a magnetic field strength in time, and an angle correction means to implant a corrected ion beam to an implantation target by correcting the scan angle in a scanning surface of the ion beam scanned by this scan means.

In the ion implantation equipment, said angle correction means can be constituted to have a function to correct the scanning angle of the ion beam in the scanning surface by adding the magnetic field changing the strength thereof in time to the ion beam scanned by said scanning means, and a function to implant the corrected ion beam to the impregnation target.

In addition, in order to achieve the above object, the ion beam generated from the ion sounce is deflected by adding the magnetic field, the ion beam having the specified mass is separated to be extracted from these ion beams and the extracted ion beam is scanned by adding a magnetic field changing the strength thereof in time, and the scan angle in the scanning surface of this scanned ion beam is corrected and the corrected ion beam is implanted to the implantation target.

### BRIEF DESCRIPTION OF THE DRAWINGS

FIG. 1A is a top plan view of the ion implantation equipment showing one embodiment of the present invention, and

FIG. 1B is a side view of the ion implantation equipment.

FIG. 2 is a figure to explain a control waveform of a control signal.

FIG. 3A is a top plan view showing another embodiment of an electromagnet for the scanning, and

FIG. 3B is a top plan view showing another embodiment of the electromagnet for the scanning.

### DETAILED DESCRIPTION OF THE PREFERRED EMBODIMENT

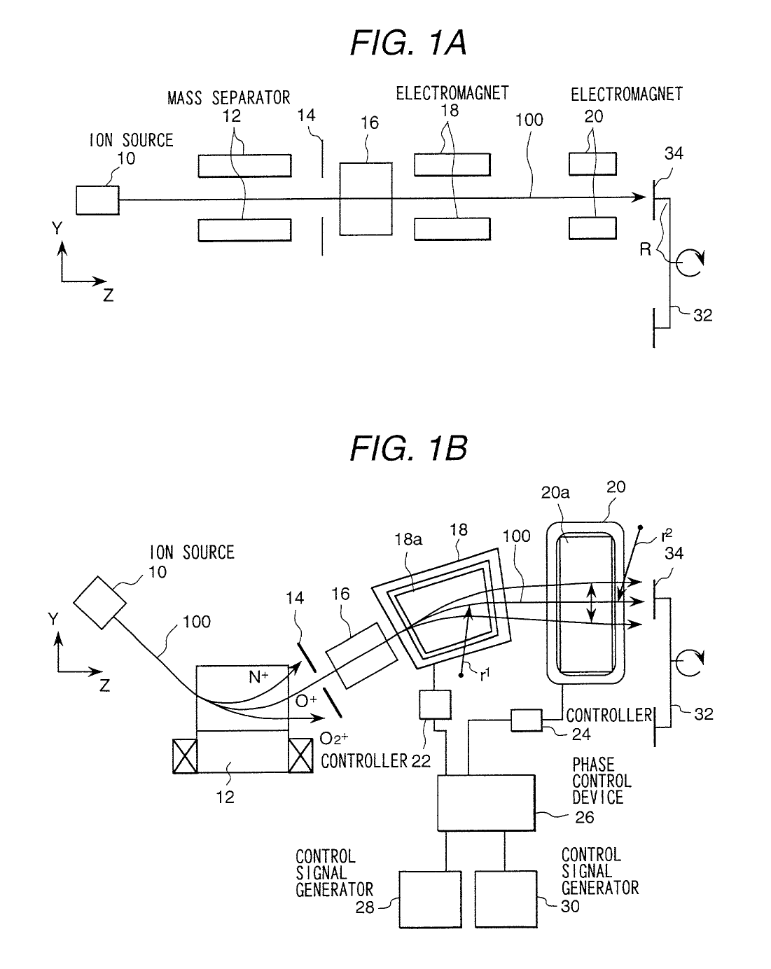

Based on a drawing, one embodiment of the present invention will be explained as follows. FIG. 1A shows a top plan view (YZ surface) of the ion implantation equipment showing one embodiment of a present invention and FIG. 1B shows a side view (XZ surface) of the ion implantation equipment. In FIG. 1,

the ion implantation equipment in the embodiment of the present invention is used, for example, as a large electric current oxygen ion implantion apparatus for SIMOX (Separation by Implanted Oxygen) substrate implementation in order to implant an oxygen ion beam of a large electric current such as 100 mA to an implantation target, and constituted with an ion sounce 10, a mass separator 12, a mass separation slit 14, an after-acceleration pipe 16, an electromagnet 18 for scanning, an electromagnet 20 for correcting angle thereof, an electric current controller 22, 24, a phase control device 26, a control signal generator 28 for scanning, a control signal generator 30 for correcting the angle and a rotating disk 32, and the plural wafers 34 are arranged on the rotating disk 32 as an imprantation target.

The ion sounce 10 has a function as a preliminary step accelerating tube, generates an ion beam and accelerates the generated ion beam, and is constructed to irradiate the accelerated ion beam 100 toward the mass separator 12 side. The mass separator 12 deflects the ion beam 100 by giving a fixed magnetic field to the ion beam 100 that occurred from the ion sounce 10 so as to go out to the mass separation slit 14 side. This deflection is performed on the XZ surface as a deflection surface, the orbit of the ion beam 100 is decided by the magnetic field storength of the mass separator 12 and energy of the ion beam 100. That is to say, considering the O+, O2+, N+ included in the ion beam 100, the magnetic field strength of the mass separator 12 is set so that the orbit of O+ keeps the designated orbit, and the mass separation slit 14 is arranged so that only O+ can pass through the mass isolation slit 14. The mass separator 12 and the mass separation slit 14 is constituted as a mass separation means to separate so as to exract an ion beam of a specified mass (O+) from the ion beam 100 occurred from the ion sounce 10.

After the ion beam 100 that passed the mass isolation slit 14 is accelerated with the after-acceleration pipe 16, it is irradiated in the electromagnet 18 for the scanning.

The electromagnet 18 for scan gives the magnetic field changing the magnetic field strength in time to the ion beam 100 from the after-acceleration pipe 16, and it is constituted as one element as a scanning means for scanning the ion beam 100. The electromagnetic coil of the electromagnet 18 for this scanning is connected to the electric current controller 22 as a scan electric current control means, and the electric current controller 22 is connected to the control signal generator 28 through the scan through phase control device 26. The control signal generator 28 for the scanning, is constituted as a control signal generating means for the scanning to generate the control signal for the scanning as an alternative current signal that an amplitude changes timewisely, and the control signal for the scanning output by this control signal generator 28 is input into the electric current controller 22 through the phase control device 26. According to input control signal, when the input voltage of the electric current controller 22 changes from 0 to 10V, the electric current to flow in the electromagnetic coil of the electromagnet 18 changes according to this change, and the magnetic field strength changes according to the change of this electric current. When the magnetic field strength changes, the deflection radius r1 changes according to this magnetic field strength, the orbit of the ion beam 100 changes according to a size of this deflection radius r1, and the ion beam 100 is deflected on the XZ surface as a scanning surface. A scanning speed in this case is set to be less than 1 Hz. That is to say, when the ion beam 100 of 100 mA is implanted in the wafer 34, an induction electric field by the ion beam 100 occurs, and the effect of the space charge that the ion beam 100 has, becomes remarkable, if the scanning speed is set larger, a beam shape of the ion beam 100 changes with the scanning of the ion beam 100. For this reason, the scan speed is set to be less than 1 Hz, for example, at a range of 0.2 to 0.8 Hz as a frequency that a change of the beam shape of the ion beam 100 is hard to happen.

In addition, section of the magnetic pole 18a of the electromagnet 18 for scanning, is formed to be a trapezoid shape so that the ion beam 100 is deflected 90 degrees for an end of the magnetic pole when the ion beam 100 is twisted.

The electromagnet 20 for correcting angle thereof, gives a magnetic field which the magnetic field strength changes timewisely to the ion beam 100 scanned by the electromagnet 18 for scanning, thereby the scan angle in the scanning surface of the ion beam 100 (XZ surface) is revised, and it is constituted as one element of an angle correction means to implant the corrected ion beam 100 into the wafer 34. The current coil of the electromagnet 20 for the angle correction is connected to an electric current controller (an angle correction electric current control means) 24, and the electric current controller 24 is connected to the control signal generator 30 for correcting the angle through the phase control device 26. The control signal generator 30 for the angle correction, is constituted as a control signal generation means for correcting the angle thereof to generate a control signal for correcting the angle as the alternative current signal that the amplitude changes timewise, and this control signal is input into the phase control device 26. The phase control device 26 is constituted as a phase control means, and the phase of control signal from control signal generator 30 for angle correction is to shifted 180 degree corresponding to the control signal from the control signal generator 28 for scan, and a control signal corrected its phase is input into the electric current controller 24. Level of the control signal irradiated into the electric current controller 24 changes by a range from 0 to 10V, and the size of the electric current supplied into the electromagnetic coil of the electromagnet 20 comes to change in time according to this change. When the electric current to flow into the electromagnetic coil changes, magnetic field strength changes according to magnitude of the electric current, and the deflection radius r2 comes to change according to the size of this magnetic field strength. When the deflection radius r2 changes according to the magnetic field strength, the deflection-angle degree of the ion beam 100 irradiated to the electromagnet 20 is corrected according to the size of deflecting radius r2, and the irradiation angle of the ion beam irradiated to the wafer 34 is corrected in all surface to keep the same angle. In addition, a section of the magnetic pole 20a of the electromagnet 20 for correcting the angle thereof, is formed to be a rectangle shape so that the ion beam 100 to be irradiated in and the ion beam 100 to outgo become to be 90 degrees against an end surface of the magnetic pole 20a.

The rotating disk 32 supports the wafer 34 so that the ion beam 100 from the electromagnet 20 for the angle correction is irradiated to the wafer 34 with roughly 90 degrees angle, and turns with a rotating radius R being a distance between a center of the wafer 34 and a center of the rotation axis. In this case, the rotating cycle of the rotating disk 32 is provided to be larger than the scanning interval, a lot of ion beams are prevented from being implanted to the specified part of the wafer 34 by mutually interfering with the scan speed. Furthermore, in SIMOX, in order to irradiate the ion beam 100 while heating the wafer 34, as it becomes difficult to heat the wafer 34 when number of the revolutions of the rotating disk 32 becomes to be so high, the rotating disk 32 is controlled to turn with a speed of 400-500 revolution per minute.

In the above constitution, when the ion beam 100 generated from the ion sounce 10 is irradiated to the mass separator 12, an ion beam (O+) having a specified mass among the ion beam 100 is separated to be extracted, and after this ion beam 100 is accelerated with the after-acceleration pipe 16, it is irradiated to the electromagnet 18 for the scanning. The ion beam 100 irradiated to the electromagnet 18 for the scanning is scanned according to a change of magnetic field strength, and the scanned ion beam 100 is irradiated into the electromagnet 20 for correcting the angle thereof. The ion beam 100 irradiated to the electromagnet 20 for the angle correction is corrected its scanning angle according to a change of the magnetic field strength and its scanning angle is corrected, and the corrected ion beam 100 is irradiated into the wafer 32 in turn.

In this way in this embodiment of the present invention, as the ion beam 100 is deflected so as to scan the wafer 32 by changing the magnetic field strength with the electromagnet 18 for scanning and the electromagnet 20 for correcting the angle thereof and an orbit of the scanned ion beam 100 is corrected thereby, the electromagnet 18 for the scanning and the electromagnet 20 for the angle correction having a simple shape can be used and the ions can be irradiated uniformly on the entire surface of the wafer 34. Moreover, as the scanning surface by the electromagnet 18 (XZ surface) for the scanning is put together in the scanning face of the mass separator 12 (XZ surface), the entire surface of the wafer 34 can can be irradiated by the ions more uniformly.

In addition, when the scanning of ±150 mm are performed from a center of 8 inches wafer conventionally, the beam width in the center of the wafer increases 1.33% at a scanned maximum location. However in the embodiment of the present invention, even if the ion beam 100 is scanned, any change in the shape of the ion beam 100 is not arisen.

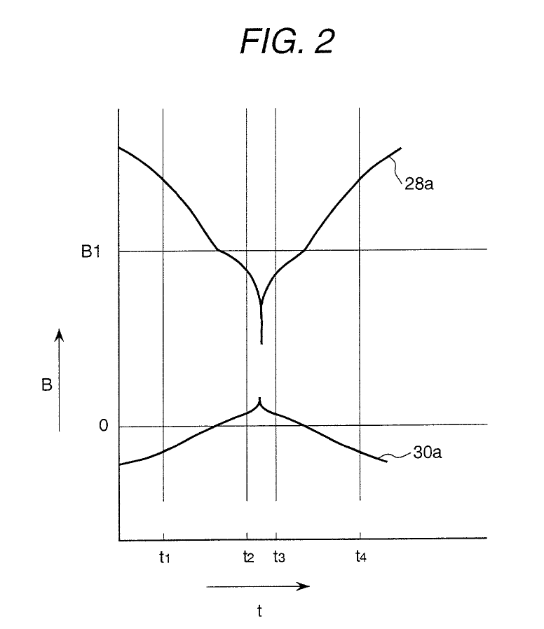

In the next, if the electromagnet 18 for the scanning and the electromagnet 20 for the angle correction are controlled in independency by using each different control signal, the control signal 28a having a waveform as shown by FIG. 2 as a control signal generated from the control signal generator 28 for the scan may be used, and a control signal 30a having a waveform as shown by FIG. 2 as a control signal generated from the control signal generator 30 for the angle correction may be used.

The control signals 28a, 30a shown in FIG. 2 shows a control waveform of one scan, while the ion beam 100 passes through inside on the wafer 34 by way of outside of one end of wafer 34, moreover turn over when passing the wafer 34, and come back again to the first location after passing othe wafer 34.

Actually, the above scanning that continued by repeating this waveform output becomes possible. BI in FIG. 2 shows a magnetic field strength when the ion beam 100 is located in a center of the wafer 34.

When electric current flowing through into the electromagnetic coil of the electromagnet 18 for the scanning and the electromagnet 20 for the angle correction changes in time according to control signal 28a, 30a, the magnetic field strength changes according to this change of the electric current. For example, when the magnetic field strength of the electromagnet 18 for the scanning increases more than B1, it shows that the deflection radius r1 of the ion beam 100 becomes small in the electromagnet 18 for the scanning, and when the magnetic field strength decreases than B1, on the contrary, it shows that the deflection radius r1 of the ion beam 100 becomes larger in the electromagnet 18 for the scanning. In this case, although the deflection radius r1 of the electromagnet 18 for the scanning changes according to the magnetic field strength, the ion beam 100 is deflected only to one direction.

On the other hand, when the electric current flowing into the electromagnetic coil of the electromagnet 20 for the angle correction is controlled according to the control signal 30a being deviated 180 degrees of phase from the control signal 28a, the magnetic field strength changes according to this change of the electric current. For example, the electromagnet 20 for the angle correction performs an angle compensation of ion beam 100, by deflecting the ion beam 100 into a direction the same as a deflection direction of the electromagnet 18 for the scanning when the magnetic field strength of the electromagnet 18 for the scanning becomes weaker than B1 and is deflected with a big deflection radius r2 for the orbit that the ion beam 100 arrives at in the center of wafer 34. On the contrary, when the magnetic field strength of the electromagnet 18 becomes stronger than B1, and it is deflected with the deflecting radius r2 which is smaller for the orbit which the ion beam 100 arrives at the center of the wafer 34, the electromagnet 20 for the angle correction deflects the ion beam 100 into a reverse direction with a deflection direction of the electromagnet 18 for the scan so as to perform an angle compensation of the ion beam 100.

When the ion beam 100 is irradiated on the entire surface of the wafer 34 uniformly, by letting the magnetic field strength of the electromagnet 18, 20 changed according to the control signal 28a, 30a, it is scanned so that the ion beam 100 completely passes out of the wafer 34, the time that the ion beam 100 is irradiated becomes from a timing t1 to a timing t2 and from a timing t3 to a timing t4. By letting the magnetic field strength change into a value of plus and minus from a center position 0, the electromagnet 20 for the angle correction becomes to change a polarity of the magnetic field. The ion beam 100 passed through the electromagnet 20 is irradiated with the same irradiation angle into all surface on the wafer 34.

In addition, the following things are considered so as to be set the control waveform of the control signal 28a, 30a. That is to say, when the ions are irradiated on the wafer 34 by scanning the ion beam 100 while turning the rotating disk 32 mounting the wafer 34, a distance from the center of the rotating disk 32 to the ion beam 100 (rotation radius=R) changes according to respective scanning at any time. On this account, the time that ion beam 100 runs across the wafer 34 varies with a location of the ion beam 100. As a result when, for example, ion beam 100 scans with a uniform speed by using a triangular wave, there are many amounts of irradiation at a rotation center side of the rotating disk 32, and on the contrary, there become a few amounts of irradiation at a contour side of the rotating disk 32. On this account, the waveform of the control signals 28a, 30a are set so as to be able to perform a so-called 1/R control, in which the scanning speed is changed in proportion to a distance of the ion beam 100 with the center of the rotating disk 32 (rotation radius: R).

Moreover, the control waveforms of the control signals 28a, 30a are changed on the basis of the irradiation resultant. For example, the waveform is changed when the shape of the ion beam 100 becomes small and amount of the irradiation is large, the ion beam 100 is scanned very first on the points inside of the wafer 34, and when the shape of the ion beam 100 becomes large and amount of the irradiation is small, the ion beam 100 is scanned very slowly on the points inside of the wafer 34. As the waveform is processed to be changed in this way, degradation of the uniformity by a change of the shape of the ion beam can be prevented, and a uniform ion implantation becomes possible.

In addition, in a case that the phase of the control signal for the angle correction is moved 180 degrees for the control signal for the scanning, it can be done simply and easily by using a microcomputer or a personal computer in stead of using the phase control device 26. Moreover in stead of using the phase control device 26, a means for generating a control signal to be moved the phase 180 degree for the phase of the control signal for the scanning can be used as the control signal generator for the angle correction.

Using the ion implantation equipment in the above stated embodiment of the present invention, in addition, for example, boron ions and oxygen ion of 180kV, 100 mA are irradiated, and uniformity of implantation iss measured, and an enough uniformity equal to or less than ±2% is provided.

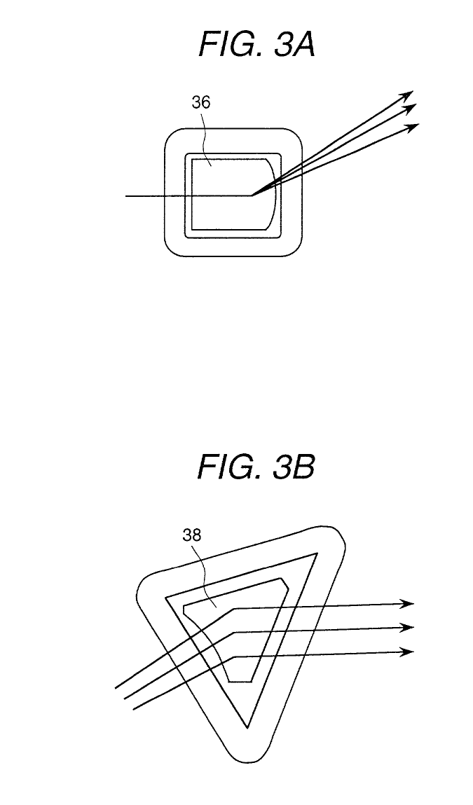

In a said embodiment configuration, a device as the electromagnet 18 for the scanning and the electromagnet 20 for the angle correction in which the magnetic field strength changes in time, is described, however one of the electromagnets becomes possible to be used a device using a fixed magnetic field. For example, an electromagnet 36 for the scanning having a magnetic pole having a curvature surface as shown in FIG. 3A can be used as an electromagnet for the scanning, and an electromagnet 38 for the angle correction having a magnetic pole having curvature surface shown in FIG. 3B, can be used as an electromagnet for angle correction.

According to the present invention explained as above, an ion beam having a specified mass is separated to be extracted from the ion beams which are generated from the ion sounce, the extracted ion beam is given the magnetic field changing the magnetic field strength in time so as to scanned, and the scan angle in the scan surface of the scanned ion beam is corrected and the corrected ion beam is irradiated to the implantation target, therefore, if the orbit of the scanned ion beam is moved off, the orbit of the scanned ion beam can be adjusted by the magnetic field, the implantation uniformity for an implantation target can be raised, and it becomes possible to contributed to improvement of yield ratio.

What is claimed is;

1. An ion implantation equipment comprising
an ion sounce,
a mass sepalation means to extract so as to separate an ion beam having a specified mass from plurality of ion beams by giving a magnetic field so as to deflect said ion beams generated from an ion sounce,
a scanning means for scanning said ion beams by giving said magnetic field changing magnetic field strength thereof in time to said ion beam extracted by said mass sepalation means, and
an angle correction means for correcting a scan angle of said ion beam scanned by said scanning means in a scanning surface so as to irradiate corrected said ion beam into an implantation target.

2. An ion implantation equipment comprising
an ion sounce,
a mass sepalation means to extract so as to separate an ion beam having a specified mass from plurality of ion beams by giving a magnetic field so as to deflect said ion beams generated from an ion sounce,
a scan means for scanning the ion beam extracted by said mass isolation means by adding magnetic field changing a magnetic field strength in time, and
an angle correction means for correcting a scanning angle in a scanning surface of said ion beam by adding said magnetic field changing magnetic field strength thereof in time to said ion beam scanned by said scanning means.

3. An ion implantation equipment as defined in claims 1 and 2, wherein
said scanning means for putting together a scanning surface of said ion beam with a deflection surfaceface of said ion beam deflected by said mass separation means.

4. An ion implantation equipment as defined in claim 2, wherein
said scanning means comprises an electromagnet for scanning to provide said magnetic field to said ion beam extracted by said mass separation means, a control signal generation means for said scanning to generate a control signal for said scanning, and a scanning electric current control means to change size in time of said electric current flowing into said electromagnet responding to said control signal for said scanning, and
said angle correction means comprises an electromagnet for angle correction to provided said magnetic field to said ion beam scanned by said scanning means, a control signal generating means for angle compensation to generate a control signal for said angle correction, and an angle correction electric current control means to change size in time of said electric current flowing into said electromagnet for said angle correction responding to said control signal for said angle correction.

5. An ion implantation equipment as defined in claim 2, wherein
said scanning means comprises an electromagnet for scanning to provide said magnetic field to said ion beam extracted by said mass separation means, a control signal generation means for said scanning to generate a control signal for said scanning, and a scanning electric current control means to change size in time of said electric current flowing into said electromagnet responding to said control signal for said scanning, and
said angle correction means comprises an electromagnet for angle correction to provided said magnetic field to said ion beam scanned by said scanning means, a control signal generating means for angle compensation to generate a control signal for said angle correction, a phase control means to move a phase of said control signal for said angle correction 180 degrees to said control signal for said scanning, and an angle correction electric current control means to change size in time of said electric current flowing into said electromagnet for said angle correction responding to said control signal for said angle correction being controlled said phase by said phase control means.

6. An ion implantation equipment as defined in claim 2, wherein
said scanning means comprises an electromagnet for scanning to provide said magnetic field to said ion beam extracted by said mass separation means, a control signal generation means for said scanning to generate a control signal for said scanning, and a scanning electric current control means to change size in time of said electric current flowing into said electromagnet responding to said control signal for said scanning, and
said angle correction means comprises an electromagnet for angle correction to provided said magnetic field to said ion beam scanned by said scanning means, a control signal generating means for angle correction to generate said control signal for said angle correction 180 degrees to said control signal for said scanning, and an angle correction electric current control means to change size in time of said electric current flowing into said electromagnet for said angle correction responding to said control signal for said angle correction.

7. An ion implantation method comprising the steps of
giving a magnetic field so as to deflect said ion beams generated from an ion sounce,
extracting so as to separate an ion beam having a specified mass from plurality of ion beams,
scanning said ion beams by giving said magnetic field changing magnetic field strength thereof in time to said ion beam extracted, and
correcting a scanning angle of said ion beam scanned in a scanning surface so as to irradiate corrected said ion beam into an implantation target.

8. An ion implantation method comprising the steps of
giving a magnetic field so as to deflect said ion beams generated from an ion sounce,
extracting so as to separate an ion beam having a specified mass from plurality of ion beams,
scanning the ion beam extracted by said mass isolation means by adding magnetic field changing a magnetic field strength in time, and
correcting a scanning angle in a scanning surface of said ion beam by adding said magnetic field changing magnetic field strength thereof in time to said ion beam scanned so as to irradiate corrected said ion beam into an implantation target.
